(19) United States
(12) Patent Application Publication
(10) Pub. No.: US 2018/0006717 A1
(43) Pub. Date: Jan. 4, 2018

(54) NETWORK CONTROLLER, OPTICAL TRANSMISSION SYSTEM, AND METHOD FOR DETERMINING FAILURE

(71) Applicant: FUJITSU LIMITED, Kawasaki-shi (JP)

(72) Inventor: SATORU OKANO, Yokohama (JP)

(73) Assignee: FUJITSU LIMITED, Kawasaki-shi (JP)

(21) Appl. No.: 15/622,498

(22) Filed: Jun. 14, 2017

(30) Foreign Application Priority Data
Jul. 4, 2016 (JP) 2016-132377

(51) Int. Cl. H04B 10/079; H04B 10/50

(52) U.S. Cl. CPC H04B 10/07953; H04B 10/50; H04B 10/0791; H04B 10/0793; H04B 10/07951

(57) ABSTRACT

There is provided a network controller configured to control a node, the network controller including a memory, and a processor coupled to the memory and the processor configured to acquire a signal quality of an optical signal transmitted on an optical transmission line to which the node is coupled, acquire transmission characteristics of the node or the optical transmission line, correct the acquired signal quality, based on the acquired transmission characteristics, and detect a variation of the corrected signal quality.

### CROSS-REFERENCE TO RELATED APPLICATION

This application is based upon and claims the benefit of priority of the prior Japanese Patent Application No. 2016-132377, filed on Jul. 4, 2016, the entire contents of which are incorporated herein by reference.

### FIELD

The embodiments discussed herein are related to a network controller, an optical transmission system, and a method for determining a failure.

### BACKGROUND

An optical communication system using an optical transmission device employs a multi-relay wavelength multiplex transmission method using an optical amplifier in order to realize a large capacity transmission and a long distance transmission accompanying an increase in communication traffic. The transmission rate of a transceiver of the optical transmission device has been increasing from 10 Gbit/sec, through 40 Gbit/sec, to 100 Gbit/sec which is in common use at present. In addition, even faster 400 Gbit/sec is entering the commercial stage.

At least one of a polarization multiplexing method, a digital coherent method and a multi-level modulation method is adopted as a technique for achieving a high-speed transmission of 100 Gbit/sec or more.

Related technologies are disclosed in, for example, Japanese Laid-Open Patent Publication No. 2015-115863 and Japanese Laid-Open Patent Publication No. 2004-289707.

### SUMMARY

According to an aspect of the invention, a network controller configured to control a node, the network controller includes a memory, and a processor coupled to the memory and the processor configured to acquire a signal quality of an optical signal transmitted on an optical transmission line to which the node is coupled, acquire transmission characteristics of the node or the optical transmission line, correct the acquired signal quality, based on the acquired transmission characteristics, and detect a variation of the corrected signal quality.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining the configuration and function of an optical transmission system according to an embodiment;

FIG. 2 is a diagram illustrating an example of data stored in a monitoring path database;

FIG. 3 is a diagram illustrating an example of correction of signal quality in a controller of the optical transmission system according to the embodiment;

FIG. 4 is a diagram illustrating an example of variation of signal quality in a normal state and variation of signal quality outside an allowable range by the controller of the optical transmission system according to the embodiment;

FIG. 5 is a flowchart of a process by the controller of the optical transmission system according to the embodiment;

FIG. 6 is a flowchart of a process by the controller of the optical transmission system according to the embodiment;

FIG. 7 is a diagram for explaining a process of analyzing the cause of a variation of a BER value by the controller of the optical transmission system according to the embodiment; and

FIG. 8 is a diagram for explaining a process of analyzing the cause of a variation of a BER value by the controller of the optical transmission system according to the embodiment.

### DESCRIPTION OF EMBODIMENTS

As the transmission speed of a transceiver increases, the transmission capacity per optical fiber is increasing. For this reason, the reliability of an optical network has become more important than ever. In the meantime, in conventional optical transmission systems, maintenance work is performed after a failure such as a signal interruption is actually detected, which may cause a time delay to recover from the failure.

Hereinafter, embodiments of a technique for predicting the occurrence of a failure in an optical transmission system in advance will be described with reference to the accompanying drawings. However, the embodiments described below are merely examples and are not intended to exclude the application of various modifications and techniques not explicitly described below.

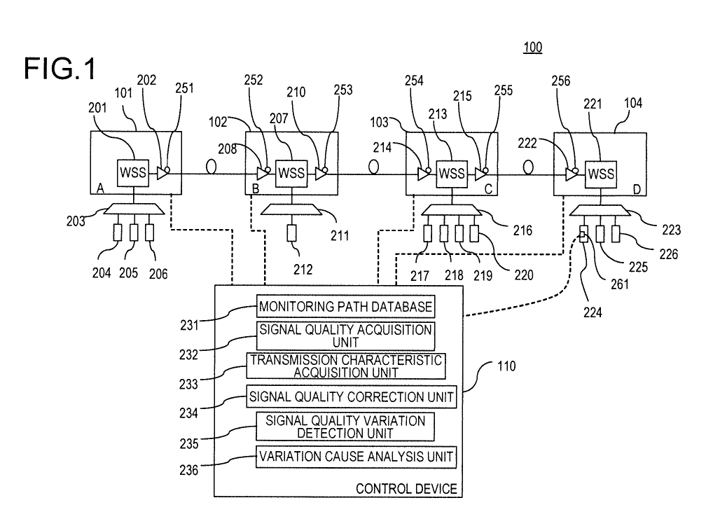

FIG. 1 is a diagram for explaining the configuration and function of an optical transmission system 100 according to an embodiment. In this example, the optical transmission system 100 is configured to include a node A 101, a node B 102, a node C 103, a node D 104, and a controller 110.

Each of the nodes A 101, B 102, C 103, and D 104 is an optical node having an optical transmission apparatus. Referring to FIG. 1, each of the node A 101 and the node B 102, the node B 102 and the node C 103, and the node C 103 and the node D 104 are respectively interconnected by an optical transmission line (e.g., an optical fiber). Therefore, according to the setting of a wavelength path, for example, when an electrical signal is input to a transponder as a transmitter connected to the optical transmission device of the node A 101, an electrical signal may be output from a transponder as a receiver connected to the optical transmission device of the node B 102. An optical signal converted from the electrical signal in the transmitter is transmitted from the optical transmission device of the node A 101 to the optical transmission device of the node B 102 via the optical transmission line and is converted into an electrical signal in the receiver.

In addition, an optical signal is transmitted, for example, from the node A 101 to the node C 103 via the node B 102. In other words, first, the optical signal is transmitted from the node A 101 to the node B 102 via the optical transmission line. Thereafter, an amplification of the optical signal and a selection of a route are performed in the node B 102, and the amplified optical signal is transmitted from the node B 102 to the node C 103 via the optical transmission line. At this time, the center wavelength of the optical signal transmitted from the node A 101 to the node B 102 becomes equal to the center wavelength of the optical signal transmitted from the node B 102 to the node C 103. This is true of the center wavelengths of optical signals transmitted between nodes via a plurality of nodes. For example, when an optical signal is transmitted from the node A 101 to the node D 104 via the node B 102 and the node C 103, the center wavelengths of the optical signals transmitted between the nodes are equal to each other.

Therefore, the wavelength path may be defined (the first definition) as a set of a node serving as a starting point, a node serving as a passing point (if any), a node serving as an end point, and the center wavelength of an optical signal. In addition, the wavelength path may further include a slot width. In other words, the wavelength path according to the second definition is a set of a node serving as a starting point, a node serving as a passing point (if any), a node serving as an end point, the center wavelength of an optical signal, and a slot width. In the following description, descriptions will be made using the former (first) definition but may also be using the second definition.

The node A 101 is a node serving as a starting point of the wavelength path. The node A 101 has a WSS 201 and a post-amplifier 202. A multiplexer 203 to which transponders 204 to 206 for adding optical signals are connected is connected to the WSS 201. The symbol WSS is an acronym for Wavelength Selection Switch. The node A may include a combination of two or more WSSs. The same is true for other nodes.

The node B 102 is a node that can be any of a starting point, an end point or a passing point of the wavelength path. The node B 102 is a node capable of transmitting the optical signal transmitted from the node A 101 to the node C 103. The node B 102 has a pre-amplifier 208 for amplifying the optical signal from the node A 101. An optical signal output from the pre-amplifier 208 is input to a WSS 207. A multiplexer/de-multiplexer 211 to which a transponder 212 for adding/dropping optical signals is connected is connected to the WSS 207. In addition, a post-amplifier 210 is connected to the WSS 207. An optical signal amplified by the post-amplifier 210 is transmitted to the node C 103.

The node C 103 is a node which can be any of a starting point, an end point or a passing point of the wavelength path. The node C 103 is a node capable of transmitting the optical signal transmitted from the node B 102 to the node D 104. The node C 103 has a pre-amplifier 214 for amplifying the optical signal from the node B 102. An optical signal output from the pre-amplifier 214 is input to a WSS 213. A multiplexer/de-multiplexer 216 to which transponders 217 to 220 for adding/dropping optical signals are connected is connected to the WSS 213. A post-amplifier 215 is connected to the WSS 213. An optical signal amplified by the post-amplifier 215 is transmitted to the node D 104.

The node D 104 is a node serving as an end point of the wavelength path. The node D 104 has a WSS 221 and a pre-amplifier 222 that is connected to the WSS 221 and amplifies the optical signal transmitted from the node C 103. The WSS 221 is connected to a de-multiplexer 223 to which transponders 224 to 226 for dropping optical signals are connected.

The post-amplifiers 202, 210 and 215 and pre-amplifiers 208, 214 and 222 include their respective optical performance monitors (OPMs) 251 to 256 on their respective output sides. These OPMs 251 to 256 are provided to monitor the transmission characteristics of node and optical transmission line from the node A 101 to the node D 104.

The transmission characteristics may be expressed by parameter values of nodes and optical transmission lines that affect signal quality. For example, the transmission characteristics are expressed by at least one of an OSNR (Optical Signal to Noise Ratio) value, a PMD (Polarization Mode Dispersion) value, a PDL (Polarization Dependent Loss) value, a CD (Chromatic Dispersion) value and a nonlinear phase noise characteristic value. Therefore, each of the OPMs 251 to 256 measures at least one of the OSNR value, the PMD value, the PDL value, the CD value and the nonlinear phase noise characteristic value.

Although it is illustrated in FIG. 1 that the post-amplifiers 202, 210 and 215 and the pre-amplifiers 208, 214 and 222 include their respective OPMs 251 to 256, some amplifiers may not be provided with an OPM.

When these OPMs 251 to 256 are provided in the wavelength path, in a case where there is an OPM that measures transmission characteristics different than normal, if an adjacent OPM measures normal transmission characteristics, it can be estimated that an abnormality occurs in an optical transmission line between the two OPMs.

The controller 110 includes a monitoring path database 231, a signal quality acquisition unit 232, a transmission characteristic acquisition unit 233, a signal quality correction unit 234, and a signal quality variation detection unit 235. The controller 110 may further include a variation cause analysis unit 236. These function units are implemented by a central processing unit (CPU) (not illustrating) executing an operating system (OS) and programs stored in a memory (not illustrating).

The monitoring path database 231 is a database that stores information on a wavelength path to be monitored. The information on a wavelength path to be monitored includes the center wavelength of an optical signal, identification information of a starting point node, identification information of a required passing point node, and identification information of an end point node.

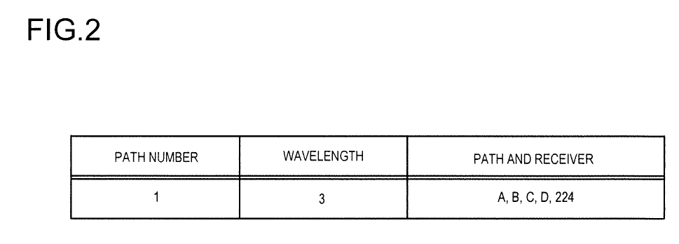

FIG. 2 is a diagram illustrating an example of information stored in the monitoring path database 231. The “path number” is information of a column storing identification information for uniquely identifying a wavelength path, and the “wavelength” is information of a column storing identification information of the center wavelength of an optical signal of a wavelength path. The “path and receiver” is information of a column storing identification information of a starting point node, identification information of a required passing point node, identification information of an end point node, and identification information of a receiver in which an optical signal transmitted to a wavelength path is received.

Referring to FIG. 2, the wavelength path in which identification information “1” is stored in the column of the path number is the wavelength path to be monitored, and identification information stored in the column of the center wavelength of an optical signal is “3”. The wavelength path assumes A 101 as a starting point, B 102 and C 103 as passing points, and D 104 as an end point. Identification information of a receiver is 224. In this example, the identification information of the receiver is indicated by a symbol illustrated in FIG. 1.

The signal quality acquisition unit 232 acquires the signal quality of an optical signal transmitted to a wavelength path to be monitored. The signal quality of the optical signal is measured by a signal quality measuring device 261 installed in the receiver 224 and the signal quality acquisition unit 232 acquires the measured signal quality. The signal quality can be measured based on, for example, a BER (Bit Error Rate) value at the time of converting an optical signal into an electrical signal and decoding the electric signal. As the BER value becomes smaller than a bit correction limit which is the upper limit of a correctable bit error rate, the signal quality may become better. Conversely, when the BER value rises and approaches the bit correction limit, the signal quality may deteriorate and the occurrence of failure of an optical network may be predicted.

The signal quality acquired by the signal quality acquisition unit 232 may be stored in a storage device included in the controller 110 in association with acquired time.

There are various reasons for deterioration of the signal quality. Therefore, a failure does not necessarily result from the deterioration of the signal quality. As will be described later, in the present disclosure, the controller 110 corrects the signal quality based on the transmission characteristics and predicts the occurrence of a failure based on variation of the corrected signal quality.

The signal quality acquisition unit 232 acquires the identification information of the receiver stored in the “path and receiver” column of the monitoring path database 231 and specifies the receiver.

The transmission characteristic acquisition unit 233 acquires values of the transmission characteristics. The transmission characteristic values are acquired from a plurality of OPMs 251 to 256 installed in the nodes A 101, B 102, C 103, and D 104.

The transmission characteristics acquired by the transmission characteristic acquisition unit 233 may be stored in the storage device included in the controller 110 in association with the acquired time for each of the OPMs 251 to 256 and each of the transmission characteristics.

The signal quality correction unit 234 corrects the signal quality acquired by the signal quality acquisition unit 232 based on the transmission characteristics acquired by the transmission characteristic acquisition unit 233.

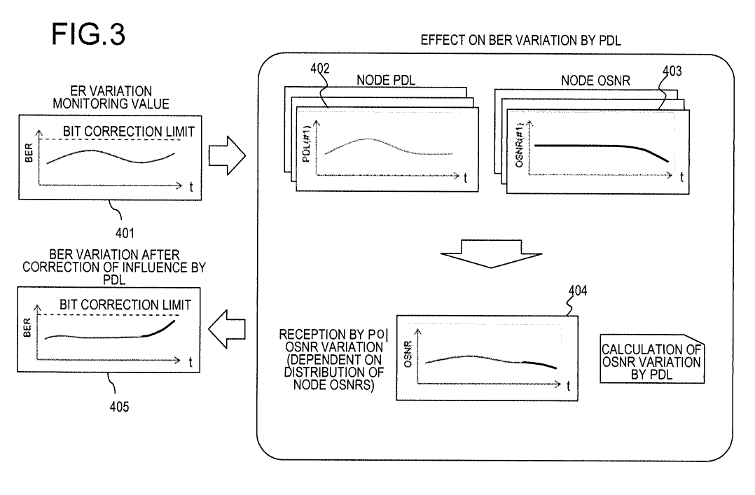

FIG. 3 is a diagram for explaining an example of correction of the signal quality based on the transmission characteristics. In the example illustrated in FIG. 3, a temporal variation of a BER value indicated by a graph 401 of FIG. 3 is obtained by the signal quality acquisition unit 232 from the signal quality measuring device 261 installed in the receiver 224. As illustrated in the graph 401, the BER value varies with the lapse of time. It is here assumed that the BER value temporarily rises, thereafter decreases, and now is rising again.

For example, a PDL value and an OSNR value are acquired by the transmission characteristic acquisition unit 233 from each of the OPMs 251 to 256. As illustrated in graphs 402 and 403, it is assumed that each of the PDL value and the OSNR value acquired from the OPM 256 varies. In other words, on the output side of the pre-amplifier 222, the PDL value temporarily rises, thereafter decreases, and now returns to a value before the temporary rise. Although the OSNR value has been kept constant, it tends to be decreasing at present.

The signal quality correction unit 234 corrects the signal quality acquired by the signal quality acquisition unit 232 based on the transmission characteristics acquired by the transmission characteristic acquisition unit 233. When the results of measurement on a plurality of characteristics are obtained as the transmission characteristics, the signal quality correction unit 234 uses the respective measurement results of the transmission characteristics to correct the signal quality. Alternatively, the signal quality correction unit 234 converts a measurement value of the transmission characteristic into a value of a specific transmission characteristic and uses the converted specific transmission characteristic value to correct the signal quality.

Hereinafter, an example in which the signal quality correction unit 234 converts each of the plurality of transmission characteristics into a specific transmission characteristic value and uses the converted specific transmission characteristic value to correct the signal quality will be described. As illustrated in FIG. 3, when a PDL value and an OSNR value are acquired as the transmission characteristics, the signal quality correction unit 234 converts, for example, the PDL value into the OSNR value. The following equation may be used for the conversion.

$$OSNR ( t ) = - 10 log ( {Σ10}^{- \frac{( {OSNR}_{n} ( t ) - \frac{{PDL}_{n} ( t )}{2} )}{10}} ) \qquad [ Eq . 1 ]$$

Where, “OSNRn(t)” is an OSNR value associated with time t at a node n, “PDLn (t)” is a PDL value at time t at the node n, “OSNR(t)” is an OSNR value used for correction of signal quality associated with time t. The symbol ‘Σ’ represents the total sum for nodes at a starting point, a passing point and an end point of a wavelength path to be monitored.

A graph 404, using the above equation, shows a variation of a received OSNR value of the receiver 224 from the PDL value varying as in the graph 402 and the OSNR value varying as in the graph 403. As illustrated in the graph 404, a corrected OSNR value temporarily rises but is currently decreasing.

Next, the signal quality correction unit 234 corrects the signal quality acquired by the signal quality acquisition unit 232 based on a result of the conversion of the variation of the corrected OSNR value into a variation of the signal quality. A variation of a BER value due to the variation of the OSNR value may vary depending on the transmitter and the receiver of the optical transmission device. The signal quality correction unit 234 may hold in advance a table that associates the variation of the OSNR value and the variation of the BER value with respect to each of the transmitter and the receiver, and may refer to the table to convert the variation of the OSNR value to the variation of the BER value.

For example, in order to correct the signal quality by using the result of the conversion of the variation of the corrected OSNR into the variation of the signal quality, the signal quality correction unit 234 subtracts the result of the conversion of the variation of the corrected OSNR into the variation of the signal quality from the signal quality acquired by the signal quality acquisition unit 232. Therefore, the BER variation of the graph 404 is subtracted from a monitored value of the BER variation illustrated in the graph 401. A result of the subtraction is illustrated in a graph 405.

As illustrated in the graph 405, after the corrected BER value is kept substantially constant, it is increasing now with its rate greater than the rate of increase of the BER value before correction. In addition, the corrected BER value approaches the bit correction limit as compared to the BER value before correction. Therefore, even when the variation of the BER value before correction is within the normal range (in other words, the allowable range), the controller 110 may correct the BER value based on the transmission characteristics, thereby allowing a failure to be predicted when it is detected that the variation of the BER value is large.

In other words, in the case of a polarization multiplexed signal (e.g., DP-QPSK (Dual Polarization Quadrature Phase Shift Keying)), the signal quality varies depending on the polarization state of an optical signal. The speed of the variation and the magnitude of the influence of the variation depend on the characteristics and installation state of an optical fiber, a PDL value and an OSNR value of the optical transmission device, and the models of the transmitter and the receiver. Therefore, it is not easy to predict a failure simply by monitoring the total of PDL values of a wavelength path at an end point node. In the meantime, as described above, a failure may be predicted with high accuracy by monitoring a PDL value and an OSNR value at each node, specifying the PDL value variation and the OSNR value variation according to a polarization variation, and determining and correcting the influence of the variation on a BER value for each transceiver.

The signal quality variation detection unit 235 detects the variation of the signal quality corrected by the signal quality correction unit 234. In other words, the signal quality variation detection unit 235 determines whether the magnitude of the signal quality variation after the correction by the signal quality correction unit 234 is an extent that does not lead to the occurrence of a fault or an extent that is outside the allowable range and leads to the occurrence of a fault. For example, the signal quality variation detection unit 235 detects that there is a variation that leads to the occurrence of a fault when the corrected signal quality continues to deteriorate and falls within a predetermined value from the correction limit, as illustrated in the graph 405 of FIG. 3.

Further, even when the variation per unit time of the signal quality corrected by the signal quality correction unit 234 is larger than a predetermined value, the signal quality variation detection unit 235 may detect that the variation is outside the allowable range. This is because, in the normal operation of the optical transmission system 100, the signal quality corrected by the signal quality correction unit 234 does not suddenly vary.

When a new wavelength path is added, the signal quality corrected by the signal quality correction unit 234 may abruptly vary. In this case, even when the variation is outside the allowable range, the signal quality variation detection unit 235 may determine that the variation does not lead to the occurrence of a failure with an exception of variation outside the allowable range. When the new wavelength path is added, the signal quality of a wavelength path to be monitored may deteriorate due to the contiguity of the wavelength of the added wavelength path to the wavelength of the wavelength path to be monitored, or nonlinear effects such as cross-phase modulation, intra-channel four-wave mixing and stimulated Raman scattering. The variation caused by such deterioration is not a variation leading to the occurrence of a failure. Therefore, the signal quality variation detection unit 235 refers to a log or the like for recording the addition of a wavelength path of the optical transmission system 100, for example, to detect whether or not the variation of the signal quality is caused by the addition of the wavelength path.

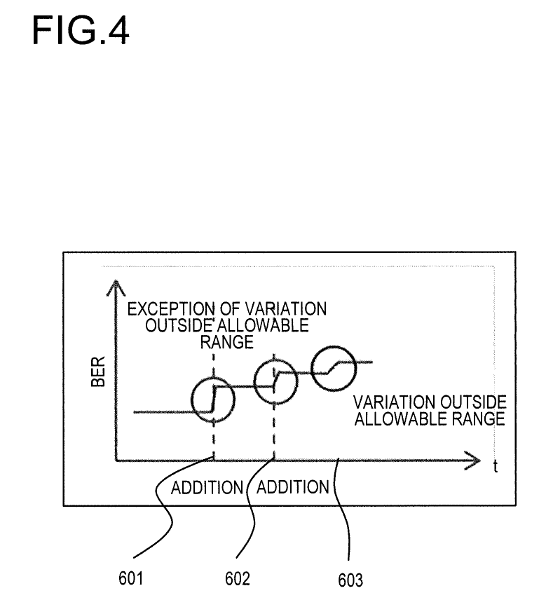

For example, as illustrated in FIG. 4, when the variation of a BER value is detected at times 601 to 603, the signal quality variation detection unit 235 refers to a log or the like for recording the addition of a wavelength path to determine whether or not a wavelength path has been added. For example, if a wavelength path is being added at time 601 and time 602, even if the variation of the corresponding BER value is outside the allowable range, the signal quality variation detection unit 235 detects that the variation does not lead to a failure. In addition, if a wavelength path is not being added at time 603, the signal quality variation detection unit 235 detects that the variation is outside the allowable range.

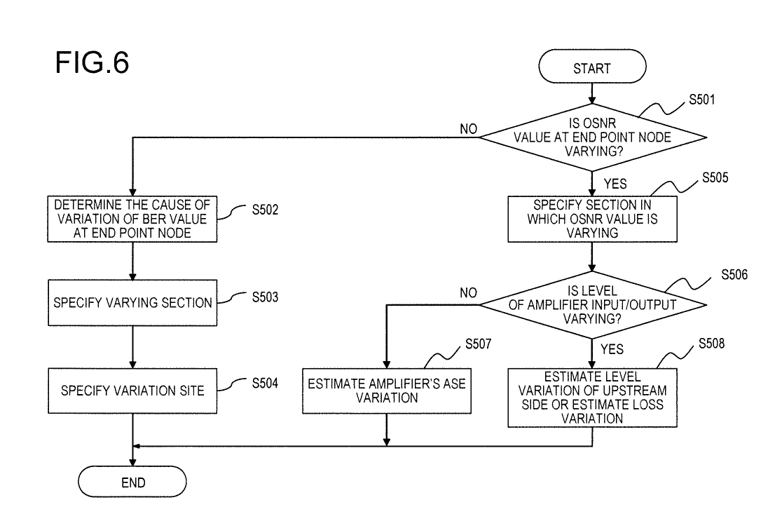

When the signal quality variation detection unit 235 detects that the variation is outside the allowable range of the signal quality, the variation cause analysis unit 236 analyzes the cause of the variation. A process of analysis by the variation cause analysis unit 236 will be described with reference to FIG. 6 et seq.

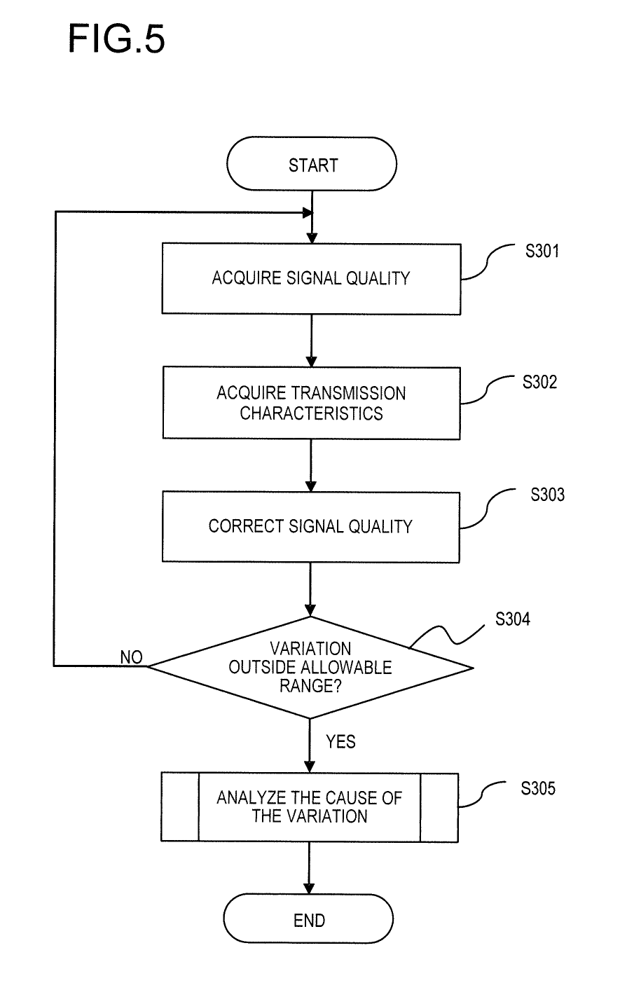

FIG. 5 is a flowchart of a process of predicting the occurrence of a failure by the controller 110. In operation S301, the signal quality acquisition unit 232 acquires signal quality. In operation S302, the transmission characteristic acquisition unit 233 acquires transmission characteristics.

The operation S301 and the operation S302 may be performed in the reverse order or in parallel.

In operation S303, the signal quality correction unit 234 corrects the signal quality.

In operation S304, the signal quality variation detection unit 235 determines whether or not the corrected signal quality indicates a variation outside an allowable range. When it is determined that the corrected signal quality indicates a variation within the allowable range, the controller 110 returns the process to the operation S301. Otherwise, when it is determined that the corrected signal quality indicates a variation outside the allowable range (in other words, shows a variation exceeding the allowable range), the controller 110 moves the process to operation S305.

In operation S305, the signal quality acquisition unit 232 analyzes the cause of the variation. The analysis on the cause of the variation is performed as described below.

FIG. 6 is a flowchart of a process of analyzing a variation by the variation cause analysis unit 236. In operation S501, for analysis on the cause of the variation, the variation cause analysis unit 236 determines whether or not an OSNR value varies at an end point node (D 104 in this example). The variation may be determined by an inquiry by the variation cause analysis unit 236 to the transmission characteristic acquisition unit 233 or the above-mentioned storage device. When it is determined that the OSNR value does not vary at the end point node D 104, the variation cause analysis unit 236 moves the process to operation S502. In contrast, when it is determined that the OSNR value varies at the end point node D 104, the variation cause analysis unit 236 moves the process to operation S506.

In the operation S502 (when the OSNR value does not vary at the end point node D 104), the variation cause analysis unit 236 specifies the cause of variation of a BER value at the end point node. For example, the variation cause analysis unit 236 specifies a varying transmission characteristic other than OSNR.

In the next operation S503, a section in which the specified transmission characteristic varies is specified. In this example, the section is a section between two adjacent OPMs, one having a transmission characteristic that does not vary and the other having a varying transmission characteristic. The section may be specified by investigating a result of measurement of OPM in the direction opposite to the transmission direction of an optical signal of a wavelength path to be monitored. For example, when a transmission characteristic measured at the pre-amplifier 208 of the node B is not normal and a transmission characteristic measured at the post-amplifier 202 of the node A, which is a node in the upstream of the node B, is normal, a section between the node A and the node B is specified.

In operation S504, the variation cause analysis unit 236 specifies a variation site for the section specified in the operation S503.

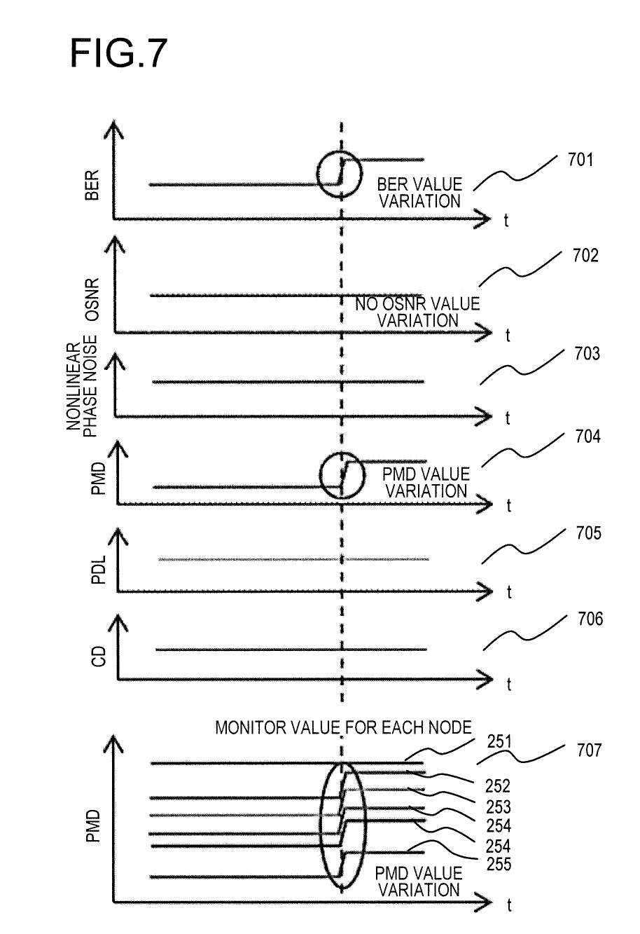

FIG. 7 is a diagram illustrating an example of a process from the operation S501 to the operation S504. It is assumed that the variation of a BER value exceeds the allowable range as illustrated in a graph 701 and an OSNR value does not vary as illustrated in a graph 702. In this case, in the operation S502, a varying one of other transmission characteristics measured by the OPM 256 of the node D 104 is specified. As illustrated in graphs 703, 705 and 706, there is no variation in a nonlinear phase noise, a PDL value and a CD value. In addition, as illustrated in a graph 704, it is specified that a PMD value varies.

When the variation of the PMD value is specified, the variation cause analysis unit 236 specifies a section in which the PMD value varies. A graph 707 illustrates that the OPM 251 does not detect the variation of the PMD value, whereas the OPM 252 and the OPMs 253 to 255 in the downstream thereof detect the variation of the PMD value. Therefore, a section between the OPM 251 and the OPM 252 is specified in the operation S503. Therefore, in the operation S504, it can be specified that the section between the node A 101 and the node B 102 is a variation site.

Therefore, the variation cause analysis unit 236 may issue an instruction to secure a spare optical transmission line between the node A 101 and the node B 102. Alternatively, by referring to a path database or the like that stores information indicating paths forming an optical transmission line, if there is a separate path from the node A 101 to the node B 102, the controller 110 may issue an instruction to make a detour with the separate path.

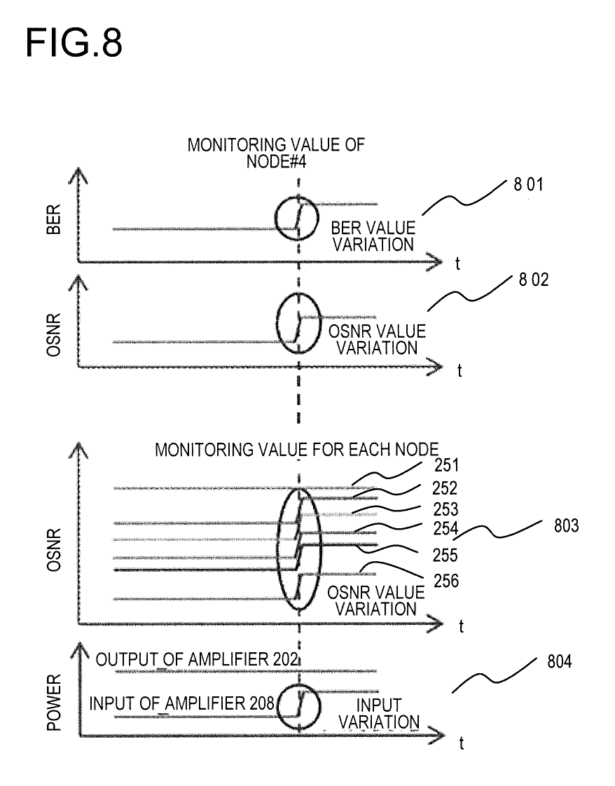

Next, a case where the OSNR value varies at the end point node (in this example, D 104) in the operation S501 will be described. For example, as illustrated in graphs 801 and 802 in FIG. 8, it is assumed that a BER value and an OSNR value vary at the node D 104.

In operation S505, a section between an OPM in which the variation of an OSNR value is detected and an adjacent OPM in which the variation of an OSNR value is not detected is specified. For example, a graph 803 illustrates a result of measurement of an OSNR value in each of the OPMs 251 to 256. According to the graph 803, the variation of the OSNR value in the OPM 251 is not detected, whereas the variation of the OSNR value in the OPM 252 is detected. Therefore, the section between the OPM 251 and the OPM 252 is specified.

In the operation S506, the variation cause analysis unit 236 determines whether or not a level of amplifier input/output within the section specified in the operation S505 varies. In the example of FIG. 8, the variation cause analysis unit 236 determines the variation of an input/output level of each of the amplifiers 202 and 208 provided respectively with the OPMs 251 and 252.

When it is determined that the amplifier input/output level is varying, the variation cause analysis unit 236 moves the process to operation S508 in which the level variation of the upstream side or the loss variation of an optical transmission line is estimated.

As illustrated in a graph 804, when it is determined that the output level of the amplifier 202 does not vary but the input level of the amplifier 208 is varying, since the node A 101 is a starting point node and no upstream node exists, the loss variation of the optical transmission line is estimated.

When it is determined that the amplifier input/output level does not vary in the operation S506, the process proceeds to operation S507 in which it is estimated that the amplifier's ASE (Amplified Spontaneous Emission) is varying.

As described above, according to the present disclosure, by providing the optical transmission system with the function of monitoring the transmission characteristics and the signal quality, the variation of the signal quality within the normal operation is corrected and the variation leading to a failure is detected, thereby making it possible to predict the failure. In addition, since the transmission characteristics are monitored using a plurality of OPMs, it is possible to identify a site of the cause of the variation of signal quality outside the allowable range of the optical transmission system. As a result, a planned maintenance work may be performed before issuance of an error due to a device alarm or the like caused by an occurrence of the failure, which may result in a reduction in the number of standby staffs and replacement spare units.

In addition, even if a failure occurs, it is possible to identify a failure location so that devices and parts necessary for recovery may be prepared beforehand to shorten the time required for recovery.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A network controller configured to control a node, the network controller comprising:
a memory; and
a processor coupled to the memory and the processor configured to:
acquire a signal quality of an optical signal transmitted on an optical transmission line to which the node is coupled;
acquire transmission characteristics of the node or the optical transmission line;
correct the acquired signal quality, based on the acquired transmission characteristics; and
detect a variation of the corrected signal quality.

2. The network controller according to claim 1, wherein the processor is configured to acquire a bit error rate (BER) value as the signal quality.

3. The network controller according to claim 1, wherein the processor is configured to acquire at least one of an optical signal noise ratio (OSNR) value, a polarization dependent loss (PDL) value, a polarization mode dispersion (PMD) value, a chromatic dispersion (CD) value, and a nonlinear phase noise characteristic value as the transmission characteristics.

4. The network controller according to claim 3, wherein, when the processor is configured to acquire two or more values of the OSNR value, the PDL value, the PMD value, the CD value, and the nonlinear phase noise characteristic value as the transmission characteristics, the processor is configured to convert the acquired two or more values to one of an OSNR value, a PDL value, a PMD value, a CD value and a nonlinear phase noise characteristic value.

5. The network controller according to claim 4, wherein the processor is configured to convert the acquired two or more values to the OSNR value.

6. The network controller according to claim 1, wherein the processor is configured to detect a variation of the signal quality caused by an addition of a wavelength path as a variation within an allowable range.

7. The network controller according to claim 6, the processor is configured to analyze a cause of a variation that is outside the allowable range of the signal quality.

8. The network controller according to claim 7, wherein the processor is configured to specify a failure section in which a failure is predicted between a first monitor which detects a variation of the transmission characteristics and a second monitor which is adjacent to the first monitor and does not detect the variation of the transmission characteristics.

9. An optical transmission system comprising:
a plurality of nodes coupled each other by an optical transmission line and configured to include a monitor to monitor transmission characteristics of the optical transmission line;
a network controller configured to include:
a memory; and
a processor coupled to the memory and the processor configured to:
acquire a signal quality of an optical signal transmitted on an optical transmission line to which the node is coupled;
acquire transmission characteristics of the node or the optical transmission line;
correct the acquired signal quality, based on the acquired transmission characteristics; and
detect a variation of the corrected signal quality.

10. The optical transmission system according to claim 9, wherein the processor is configured to acquire a bit error rate (BER) value as the signal quality.

11. The optical transmission system according to claim 9, wherein the processor is configured to acquire at least one of an optical signal noise ratio (OSNR) value, a polarization dependent loss (PDL) value, a polarization mode dispersion (PMD) value, a chromatic dispersion (CD) value, and a nonlinear phase noise characteristic value as the transmission characteristics.

12. The network controller according to claim 11, wherein, when the processor is configured to acquire two or more values of the OSNR value, the PDL value, the PMD value, the CD value, and the nonlinear phase noise characteristic value as the transmission characteristics, the processor is configured to convert the acquired two or more values to one of an OSNR value, a PDL value, a PMD value, a CD value and a nonlinear phase noise characteristic value.

13. The optical transmission system according to claim 12, wherein the processor is configured to convert the acquired two or more values to the OSNR value.

14. The optical transmission system according to claim 9, wherein the processor is configured to detect a variation of the signal quality caused by an addition of a wavelength path as a variation within an allowable range.

15. The optical transmission system according to claim 14, the processor is configured to analyze a cause of a variation that is outside the allowable range of the signal quality.

16. The optical transmission system according to claim 15, wherein the processor is configured to specify a failure section in which a failure is predicted between a first monitor which detects a variation of the transmission characteristics and a second monitor which is adjacent to the first monitor and does not detect the variation of the transmission characteristics.

17. A method for determining a failure, the method comprising:
acquiring a signal quality of an optical signal transmitted on an optical transmission line to which the node is coupled;
acquiring transmission characteristics of the node or the optical transmission line;
correcting the acquired signal quality, based on the acquired transmission characteristics; and
detecting a variation of the corrected signal quality, by a processor.

18. The method according to claim 17, wherein the processor is configured to acquire a bit error rate (BER) value as the signal quality.

19. The method according to claim 17, wherein the processor is configured to acquire at least one of an optical signal noise ratio (OSNR) value, a polarization dependent loss (PDL) value, a polarization mode dispersion (PMD) value, a chromatic dispersion (CD) value, and a nonlinear phase noise characteristic value as the transmission characteristics.

20. The method according to claim 19, wherein, when the processor is configured to acquire two or more of the OSNR value, the PDL value, the PMD value, the CD value, and the nonlinear phase noise characteristic value as the transmission characteristics, the processor is configured to convert the acquired two or more values to one of an OSNR value, a PDL value, a PMD value, a CD value and a nonlinear phase noise characteristic value.
